(19) United States
(12) Patent Application Publication
(10) Pub. No.: US 2025/0211002 A1
(43) Pub. Date: Jun. 26, 2025

(54) PROTECTION CIRCUIT AND CHARGING DEVICE

(71) Applicant: OMRON HEALTHCARE Co., Ltd., Kyoto (JP)

(72) Inventors: Kosuke ABE, Kyoto (JP); Shuhei MUNEHIRA, Kyoto (JP)

(21) Appl. No.: 19/075,537

(22) Filed: Mar. 10, 2025

Related U.S. Application Data
(63) Continuation of application No. PCT/JP2023/041815, filed on Nov. 21, 2023.

(30) Foreign Application Priority Data
Mar. 15, 2023 (JP) 2023-040738

(51) Int. Cl. H02J 7/00; H01M 10/46

(52) U.S. Cl. CPC H02J 7/0029; H01M 10/46

(57) ABSTRACT

A protection circuit configured to connect: a contact positive electrode terminal, a first contact negative electrode terminal, and a second contact negative electrode terminal that are exposed to an outside in a connector portion connected to a device including a secondary battery; and a positive electrode terminal and a ground terminal provided in a power output unit configured to output power supplied to the secondary battery via the contact positive electrode terminal, the first contact negative electrode terminal, and the second contact negative electrode terminal. The protection circuit uses a P-type MOSFET between the contact positive and positive terminals, with five paths: one links the contact positive to the MOSFET's drain, another connects the positive terminal to the source, a third ties the source path to the first negative terminal via a resistor, a fourth connects the gate to the resistor junction, and a fifth grounds the second negative terminal.

### CROSS-REFERENCE TO RELATED APPLICATIONS

This application is the U.S. national stage application filed pursuant to 35 U.S.C. 365(c) and 120 as a continuation of International Patent Application No. PCT/JP2023/041815, filed Nov. 21, 2023, which application claims priority to Japanese Patent Application No. 2023-040738, filed Mar. 15, 2023, which applications are incorporated herein by reference in their entireties.

### TECHNICAL FIELD

The present invention relates to a protection circuit and a charging device including the same.

### BACKGROUND ART

Conventionally, when an electronic device incorporating a secondary battery is charged, the charging is started after the state of the secondary battery is confirmed using three terminals.

In a charger for charging such a secondary battery, safety is eventually secured against a leakage current from an exposed terminal portion to a human body (see Patent Document 1).

### CITATION LIST

### Patent Literature

Patent Document 1: JP 11-178220 A

### SUMMARY OF INVENTION

### Technical Problem

However, in such a configuration, since a component or a circuit for receiving information such as a voltage value or a temperature of the secondary battery is required on the charger side, the configuration is complicated.

In view of the above-described conventional technique, an object of the present invention is to provide a technique capable of ensuring safety against a leakage current to a human body with a simple configuration.

### Solution to Problem

In order to solve the above-mentioned problem, the present invention is characterized by a protection circuit configured to connect:
a contact positive electrode terminal, a first contact negative electrode terminal, and a second contact negative electrode terminal that are exposed to an outside in a connector portion connected to a device including a secondary battery; and
a positive electrode terminal and a ground terminal provided in a power output unit configured to output power supplied to the secondary battery via the contact positive electrode terminal, the first contact negative electrode terminal, and the second contact negative electrode terminal, wherein
the protection circuit includes:
a P-type metal-oxide-semiconductor field-effect transistor (MOSFET) connected between the contact positive electrode terminal and the positive electrode terminal;
a first electrical path configured to connect the contact positive electrode terminal and a drain terminal of the P-type MOSFET;
a second electrical path configured to connect the positive electrode terminal and a source terminal of the P-type MOSFET;
a third electrical path configured to connect the second electrical path and the first contact negative electrode terminal via a resistor;
a fourth electrical path configured to connect a gate terminal of the P-type MOSFET between the first contact negative electrode terminal and the resistor of the third electrical path; and
a fifth electrical path configured to connect the second contact negative electrode terminal and the ground terminal.

According to this configuration, even when a person touches any two of the contact positive electrode terminal, the first contact negative electrode terminal, and the second contact negative electrode terminal exposed to the outside, and the any two touched terminals are electrically connected via a human body, the P-type MOSFET is not turned on, so that a leakage current does not flow through the human body or only a weak leakage current flows through the human body. Therefore, safety can be ensured with a simple configuration using the P-type MOSFET and the passive component, which does not require a complicated configuration such as a control unit.

The present invention is also characterized by a protection circuit configured to connect:
a contact positive electrode terminal, a first contact negative electrode terminal, and a second contact negative electrode terminal that are exposed to an outside in a connector portion connected to a device including a secondary battery; and
a positive electrode terminal and a ground terminal provided in a power output unit configured to output power supplied to the secondary battery via the contact positive electrode terminal, the first contact negative electrode terminal, and the second contact negative electrode terminal, wherein
the protection circuit includes:
a PNP transistor connected between the contact positive electrode terminal and the positive electrode terminal;
a first electrical path configured to connect the contact positive electrode terminal and a collector terminal of the PNP transistor;
a second electrical path configured to connect the positive electrode terminal and an emitter terminal of the PNP transistor;
a third electrical path configured to connect the second electrical path and the first contact negative electrode terminal via a resistor;
a fourth electrical path configured to connect a base terminal of the PNP transistor between the first contact negative electrode terminal and the resistor of the third electrical path; and
a fifth electrical path configured to connect the second contact negative electrode terminal and the ground terminal.

According to this configuration, even when a person touches any two of the contact positive electrode terminal, the first contact negative electrode terminal, and the second contact negative electrode terminal exposed to the outside, and the any two touched terminals are electrically connected via a human body, the PNP transistor is not turned on, so that a leakage current does not flow through the human body or only a weak leakage current flows through the human body. Therefore, safety can be ensured with a simple configuration using the PNP transistor and the passive component, which does not require a complicated configuration such as a control unit.

The present invention is also characterized by a protection circuit configured to connect:
a contact positive electrode terminal, a first contact negative electrode terminal, and a second contact negative electrode terminal that are exposed to an outside in a connector portion connected to a device including a secondary battery; and
a positive electrode terminal and a ground terminal provided in a power output unit configured to output power supplied to the secondary battery via the contact positive electrode terminal, the first contact negative electrode terminal, and the second contact negative electrode terminal, wherein
the protection circuit includes:
an N-type metal-oxide-semiconductor field-effect transistor (MOSFET) connected between the first contact negative electrode terminal and the ground terminal;
a sixth electrical path configured to connect the first contact negative electrode terminal and a drain terminal of the N-type MOSFET;
a seventh electrical path configured to connect the ground terminal and a source terminal of the N-type MOSFET;
an eighth electrical path configured to connect the seventh electrical path and the second contact negative electrode terminal via a resistor;
a ninth electrical path configured to connect a gate terminal of the N-type MOSFET between the first contact negative electrode terminal of and the resistor the eighth electrical path; and
a tenth electrical path configured to connect the contact positive electrode terminal and the positive electrode terminal.

According to this configuration, even when a person touches any two of the contact positive electrode terminal, the first contact negative electrode terminal, and the second contact negative electrode terminal exposed to the outside, and the any two touched terminals are electrically connected via a human body, the N-type MOSFET is not turned on, so that a leakage current does not flow through the human body or only a weak leakage current flows through the human body. Therefore, safety can be ensured with a simple configuration using the N-type MOSFET and the passive component, which does not require a complicated configuration such as a control unit.

The present invention is also characterized by a protection circuit configured to connect:
a contact positive electrode terminal, a first contact negative electrode terminal, and a second contact negative electrode terminal that are exposed to an outside in a connector portion connected to a device including a secondary battery; and
a positive electrode terminal and a ground terminal provided in a power output unit configured to output power supplied to the secondary battery via the contact positive electrode terminal, the first contact negative electrode terminal, and the second contact negative electrode terminal, wherein
the protection circuit includes:
an NPN transistor connected between the first contact negative electrode terminal and the ground terminal;
a sixth electrical path configured to connect the first contact negative electrode terminal and a collector terminal of the NPN transistor;
a seventh electrical path configured to connect the ground terminal and an emitter terminal of the NPN transistor;
an eighth electrical path configured to connect the seventh electrical path and the second contact negative electrode terminal via a resistor;
a ninth electrical path configured to connect a base terminal of the NPN transistor between the first contact negative electrode terminal and the resistor of the eighth electrical path; and
a tenth electrical path configured to connect the contact positive electrode terminal and the positive electrode terminal.

According to this configuration, even when a person touches any two of the contact positive electrode terminal, the first contact negative electrode terminal, and the second contact negative electrode terminal exposed to the outside, and the any two touched terminals are electrically connected via a human body, the NPN transistor is not turned on, so that a leakage current does not flow through the human body or only a weak leakage current flows through the human body. Therefore, safety can be ensured with a simple configuration using the NPN transistor and the passive component, which does not require a complicated configuration such as a control unit.

The present invention is characterized by a charging device comprising the protection circuit, wherein
in the connector portion, the contact positive electrode terminal, the first contact negative electrode terminal, and the second contact negative electrode terminal are arranged asymmetrically.

According to this configuration, since the contact positive electrode terminal, the first contact negative electrode terminal, and the second contact negative electrode terminal are arranged asymmetrically, connection in a wrong direction with respect to an electronic device having the arrangement of the terminals corresponding thereto can be prevented.

The present invention is characterized by a charging device comprising the protection circuit, wherein
in the connector portion, the first contact negative electrode terminal and the second contact negative electrode terminal are arranged symmetrically with respect to the contact positive electrode terminal.

According to this configuration, since the first contact negative electrode terminal and the second contact negative electrode terminal are arranged symmetrically with respect to the contact positive electrode terminal, even when the first contact negative electrode terminal and the second contact negative electrode terminal are connected to the electronic device having the arrangement of the terminals corresponding thereto so as to be reversed with respect to the contact positive electrode terminal, the charger and the electronic device can be appropriately electrically connected to charge the secondary battery.

The present invention is characterized by a charging device comprising the protection circuit, wherein
in the connector portion, the contact positive electrode terminal and the second contact negative electrode terminal are arranged symmetrically with respect to the first contact negative electrode terminal.

According to this configuration, since the positive electrode terminal and the second contact negative electrode terminal are arranged symmetrically with respect to the first contact negative electrode terminal, even when the contact positive electrode terminal and the second contact negative electrode terminal are connected to the electronic device having the arrangement of the terminals corresponding thereto so as to be reversed with respect to the first contact negative electrode terminal, the charger and the electronic device can be appropriately electrically connected to charge the secondary battery.

### Advantageous Effects of Invention

According to the present invention, safety against a leakage current to a human body can be ensured with a simple configuration.

### BRIEF DESCRIPTION OF DRAWINGS

FIG. 1 is a circuit diagram of a charger according to Example 1.

FIG. 2 is a circuit diagram illustrating a normal connection state between the charger and an electronic device according to Example 1.

FIG. 3 is a diagram illustrating an electrical connection between the charger according to Example 1 and a person.

FIG. 4 is a diagram illustrating another electrical connection between the charger according to Example 1 and a person.

FIG. 5 is a diagram illustrating another electrical connection between the charger according to Example 1 and a person.

FIG. 6 is a circuit diagram of a charger according to a modified example of Example 1.

FIG. 7 is a circuit diagram of a charger according to Example 2.

FIG. 8 is a circuit diagram of a charger according to a modified example of Example 2.

FIG. 9 is a diagram illustrating an arrangement of terminals in the charger according to the examples.

FIG. 10 is a diagram illustrating another arrangement of the terminals in the charger according to the examples.

### DESCRIPTION OF EMBODIMENTS

Embodiments of the present invention will be specifically described below with reference to the drawings.

### Example 1

Hereinafter, an example of the embodiments of the present invention will be described. It should be noted that the dimension, material, shape, relative arrangement, and the like of the components described in the present examples are not intended to limit the scope of this invention to them alone, unless otherwise stated.

### Configuration of Charger

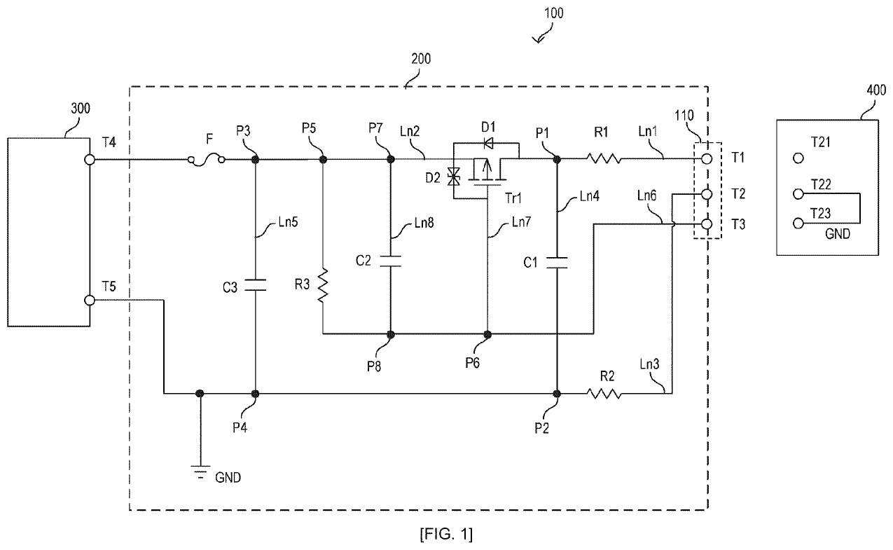

FIG. 1 is a circuit diagram including a protection circuit 200 of a charger 100 according to Example 1.

The charger 100 is connected to an electronic device 400 including a secondary battery, and supplies power to the secondary battery. The charger 100 includes a connector portion 110 connected to the electronic device 400. In the connector portion 110, terminals T1, T2, and T3 electrically connected to terminals T21, T22, and T23 on the electronic device 400 side, respectively, are provided so as to be exposed to the outside. Here, the charger 100, the connector portion 110, and the protection circuit 200 correspond to the charging device, the connector portion, and the protection circuit of the present invention, respectively. The electronic device 400 corresponds to the device according to the present invention. Further, the terminals T1, T2, and T3 correspond to the contact positive electrode terminal, the second contact negative electrode terminal, and the first contact negative electrode terminal of the present invention, respectively.

The protection circuit 200 is provided between the terminals T1, T2, and T3 and a positive electrode terminal T4 and a ground terminal T5 of an output unit 300. The output unit 300 is electrically connected via the protection circuit 200 and the terminals T1, T2, and T3, and outputs power to the secondary battery of the electronic device 400. The output unit 300 may be a component or a circuit capable of outputting power to the protection circuit 200 via the positive electrode terminal T4, and may be, for example, a power conversion apparatus such as a converter connected to a commercial power system or a connector connected to the power conversion apparatus. The output unit 300 corresponds to the power output unit of the present invention.

The terminal T1 is connected to the drain terminal of a p-channel enhancement-mode metal-oxide-semiconductor field-effect transistor (p-MOSFET) Tr1 by an electrical path Ln1. In the electrical path Ln1, a resistor R1 is connected in series between the terminal T1 and the drain terminal of the p-MOSFET Tr1. The source terminal of the p-MOSFET Tr1 is connected to the positive electrode terminal T4 of the output unit 300 by an electrical path Ln2. In the electrical path Ln2, a fuse F is connected between the positive electrode terminal T4 and the source terminal of the p-MOSFET Tr1. Here, the p-MOSFET Tr1 corresponds to the P-type MOSFET of the present invention, and the electrical path Ln1 and the electrical path Ln2 correspond to the first electrical path and the second electrical path of the present invention, respectively.

The terminal T2 is connected to the ground terminal T5 of the output unit 300 by an electrical path Ln3. In the electrical path Ln3, a resistor R2 is connected in series between the terminal T2 and the ground terminal T5. The electrical path Ln3 is grounded by a ground line GND. Here, the electrical path Ln3 corresponds to the fifth electrical path of the present invention.

A capacitor C1 is connected in series to an electrical path Ln4 that connects a connection point P1 between the resistor R1 and the drain terminal of the p-MOSFET Tr1 of the electrical path Ln1 and a connection point P2 between the resistor R2 and the ground terminal T5 of the electrical path Ln3. A connection point P3 of the electrical path Ln2 between the source terminal of the p-MOSFET Tr1 and the fuse F and a connection point P4 between the connection point P2 of the electrical path Ln3 and the ground line GND are connected by an electrical path Ln5. In the electrical path Ln5, a capacitor C3 is connected in series between the connection point P3 and the connection point P4.

The terminal T3 is connected to a connection point P5 of the electrical path Ln2 by an electrical path Ln6. The connection point P5 is provided closer to the source terminal of the p-MOSFET Tr1 than the connection point P3 is. A resistor R3 is connected in series between the terminal T3 and the connection point P5 of the electrical path Ln6. Here, the electrical path Ln6 corresponds to the third electrical path of the present invention, and the resistor R3 corresponds to the resistor of the present invention.

An electrical path Ln7, which is connected to the gate terminal of the p-MOSFET Tr1, is connected at a connection point P6 between the terminal T3 and the resistor R3 of the electrical path Ln6. A connection point P7 of the electrical path Ln2, which is provided between the source terminal of the p-MOSFET Tr1 and the connection point P5, and a connection point P8 of the electrical path Ln6, which is provided between the resistor R3 and the connection point P6, are connected by an electrical path Ln8. A capacitor C3 is connected in series to the electrical path Ln5. Here, the electrical path Ln7 corresponds to the fourth electrical path of the present invention.

A diode D1 having a forward direction from the drain terminal to the source terminal of the p-MOSFET Tr1 is connected in parallel between the source terminal and the drain terminal. A bi-directional transient voltage suppressor (TVS) diode D2 is connected in parallel between the gate terminal and the source terminal of the p-MOSFET Tr1.

As illustrated in FIG. 1, in a state where the electronic device 400 and the charger 100 are not connected, the terminal T2 and the terminal T3 are not connected, and the gate terminal and the source terminal of the p-MOSFET Tr1 are connected by the resistor R3 and the capacitor C2 connected in parallel between the electrical path Ln2 and the electrical path Ln7. Since the p-MOSFET Tr1 is in the off state, no charging voltage is applied to the terminals T1, T2, and T3.

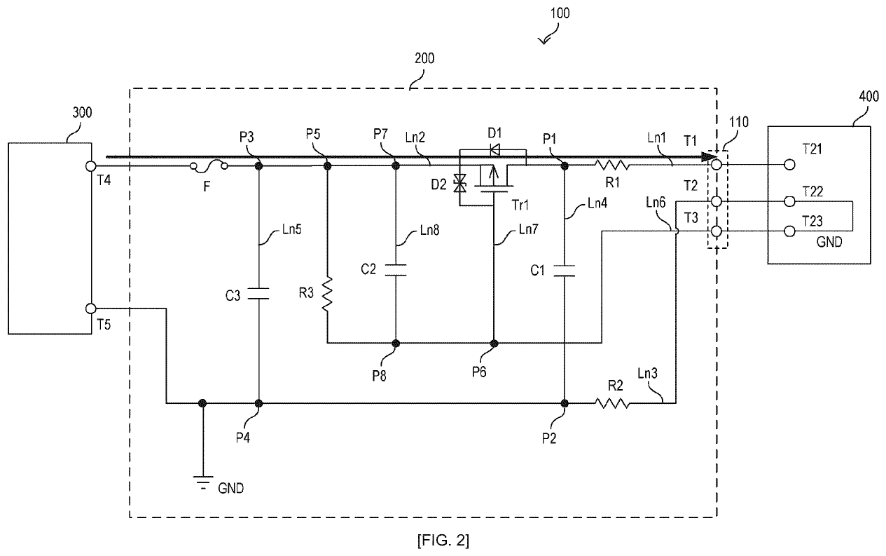

As illustrated in FIG. 2, in a state where the electronic device 400 and the charger 100 are connected to each other, the terminal T1, the terminal T2, and the terminal T3 of the charger 100 are connected to the terminals T21, T22, and T23 of the electronic device 400, respectively. Therefore, the p-MOSFET Tr1 is turned on, and the secondary battery of the electronic device 400 can be charged from the output unit 300 via the protection circuit 200 as indicated by a thick arrow.

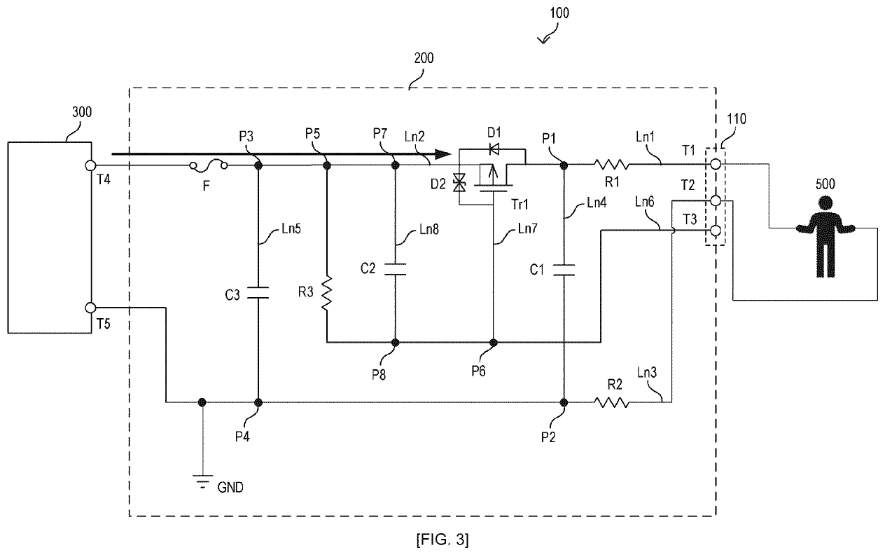

FIG. 3 illustrates a state in which a person 500 touches the terminal T1 and the terminal T2 exposed to the outside of the charger 100. At this time, the terminal T1 and the terminal T2 are connected to each other via the person 500, but the terminal T2 and the terminal T3 are not connected to each other, and the p-MOSFET Tr1 is in the off state, so that no leakage current dangerous to the person 500 flows.

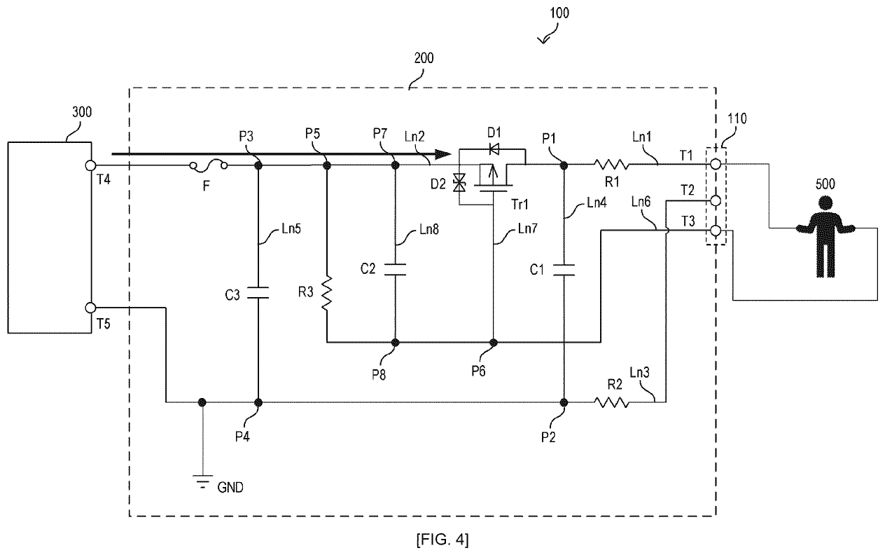

FIG. 4 illustrates a state in which the person 500 touches the terminal T1 and the terminal T3 exposed to the outside of the charger 100. At this time, the terminal T1 and the terminal T3 are connected to each other via the person 500, but the terminal T2 and the terminal T3 are not connected to each other, and the p-MOSFET Tr1 is in the off state, so that no leakage current dangerous to the person 500 flows.

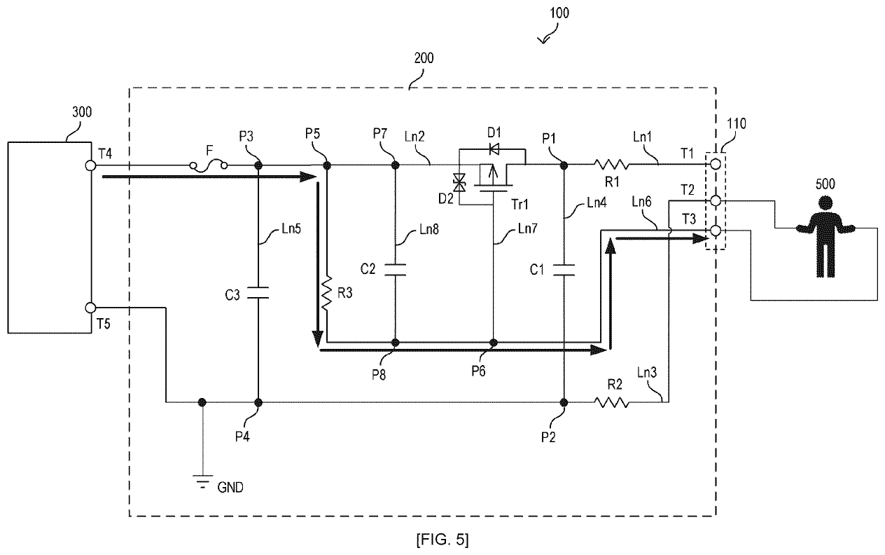

FIG. 5 illustrates a state in which the person 500 touches the terminal T2 and the terminal T3 exposed to the outside of the charger 100. At this time, the terminal T2 and the terminal T3 are connected to each other via the person 500, but the p-MOSFET Tr1 is in the off state. Therefore, as indicated by thick arrows, in the positive electrode terminal T4 of the output unit 300 and the person 500, through an electrical path formed by connecting the electrical path Ln2 and the electrical path Ln6 via the connection point P5, the current output from the positive electrode terminal T4 of the output unit 300 flows to the person 500 via the terminal T3. However, by setting the resistance value of the resistor R3 to a large value of, for example, 4070 kΩ, the leakage current can be suppressed to about less than 100 μA, which is the standard in medical devices, so that a leakage current dangerous to the human body does not flow.

As described above, according to the present Example 1, safety against a leakage current to a human body can be ensured by the protection circuit 200 having a simple configuration including passive components and transistors.

### Modified Example

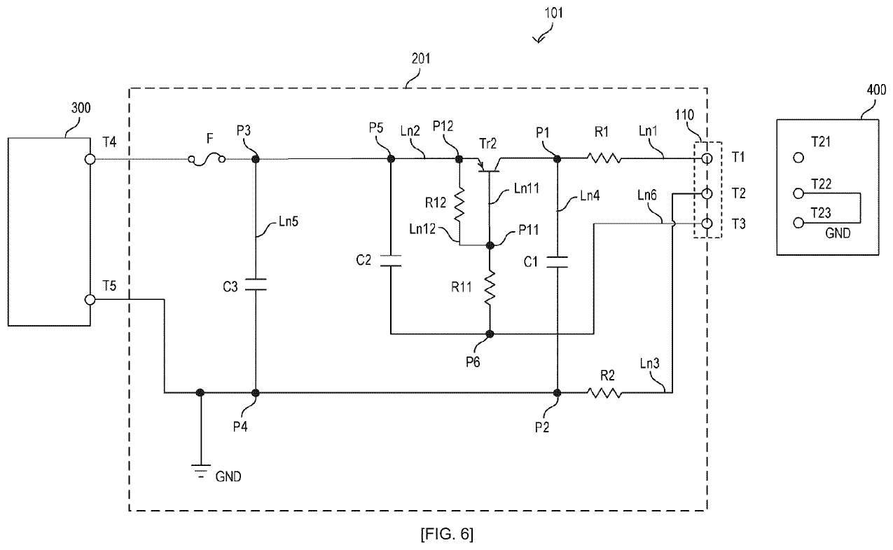

FIG. 6 is a circuit diagram including a protection circuit 201 of a charger 101 according to a modified example of Example 1. The same components as those of the protection circuit 200 according to Example 1 are denoted by the same reference numerals, and a detailed description thereof will be omitted.

In the protection circuit 201, a PNP transistor Tr2 is used instead of the p-MOSFET Tr1. Here, an emitter terminal of the PNP transistor Tr2 is connected to the positive electrode terminal T4 via the fuse F by the electrical path Ln2. Further, a collector terminal of the PNP transistor Tr2 is connected to the terminal T1 by the electrical path Ln1. A base terminal of the PNP transistor Tr2 is connected by an electrical path Ln11 to the electrical path Ln6 connecting the terminal T3 and the electrical path Ln2. In the electrical path Ln11, a resistor R11 is connected in series between the base terminal of the PNP transistor Tr2 and the connection point P6 with the electrical path Ln6. A resistor R12 is connected in parallel between the emitter terminal and the base terminal of the PNP transistor Tr2. The resistor R12 is connected in series to an electrical path Ln12 that is connected to the electrical path Ln11 at a connection point P11 and that is connected to the electrical path Ln2 at a connection point P12. At this time, the capacitor C2 is connected in series to the electrical path Ln6 connecting the terminal T3 and the electrical path Ln2.

Here, the PNP transistor Tr2 corresponds to the PNP transistor of the present invention. In addition, a section from the terminal T3 to the connection point P6 of the electrical path Ln6, a section from the connection point P6 to the connection point P11 of the electrical path Ln11, and a section from the connection point P11 to the connection point P12 of the electrical path Ln12 correspond to the third electrical path of the present invention. Further, the resistor R12 corresponds to the resistor of the present invention. A section from the connection point P11 to the base terminal of the PNP transistor Tr2 of the electrical path Ln11 corresponds to the fourth electrical path of the present invention.

The operation when the charger 101 having the protection circuit 201 is connected to the electronic device 400 is the same as that described for the charger 100. In addition, the operation of the protection circuit 201 when the person 500 touches any two of the terminals T1, T2, and T3 of the charger 101 is the same as that described for the protection circuit 200, and thus the description thereof will be omitted.

As described above, according to the present modified example, safety against a leakage current to a human body can be ensured by the protection circuit 201 having a simple configuration including passive components and transistors.

### Example 2

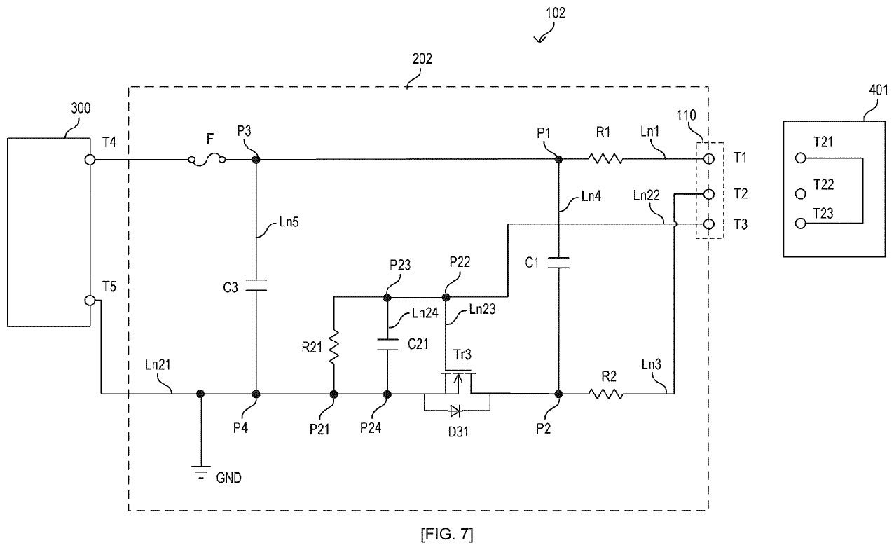

FIG. 7 is a circuit diagram including a protection circuit 202 of a charger 102 according to Example 2. The same components as those of the charger 100 and the protection circuit 200 according to Example 1 are denoted by the same reference numerals, and a detailed description thereof will be omitted.

In the protection circuit 202, an n-MOSFET Tr3 is provided not on the electrical path connecting the positive electrode terminal T4 and the terminal T1 but on the electrical path connecting the ground terminal T5 and the terminal T2.

An electrical path Ln3 has one end connected to the terminal T2 and the other end connected via the resistor R2 to the drain terminal of the n-MOSFET Tr3. The source terminal of the n-MOSFET Tr3 is connected to the ground terminal T5 by an electrical path Ln21. Here, the n-MOSFET Tr3 corresponds to the N-type MOSFET of the present invention. The electrical path Ln3 and the electrical path Ln21 correspond to the sixth electrical path and the seventh electrical path of the present invention, respectively.

Here, the terminal T3 is connected to the electrical path Ln21 at a connection point P21 via an electrical path Ln22. A resistor R21 is connected in series to the electrical path Ln22. The gate terminal of the n-MOSFET Tr3 is connected to the electrical path Ln22 at a connection point P22 via an electrical path Ln23. A capacitor C21 is connected between the electrical path Ln22 and the electrical path Ln21 by an electrical path Ln24. By the electrical path Ln24, the capacitor C21 is connected at one end to the electrical path Ln22 at a connection point P23 between the connection point P22 of the electrical path Ln22 and the resistor R21, and at the other end to the electrical path Ln21 at a connection point P24 between the source terminal of n-MOSFET Tr3 and the connection point P21. The electrical path Ln1 connects the terminal T1 and the positive electrode terminal T4, and on the electrical path Ln1, the fuse F, the connection point P3, the connection point P1, and the resistor R1 are arranged in this order from the positive electrode terminal T4 side. Here, the electrical path Ln22 corresponds to the eighth electrical path of the present invention, and the resistor R21 corresponds to the resistor of the present invention. The electrical path Ln23 corresponds to the ninth electrical path of the present invention. The electrical path Ln1 corresponds to the tenth electrical path of the present invention.

In the protection circuit 202 as described above, the electrical path Ln3 and the electrical path Ln21 connecting the terminal T2 and the ground terminal T5 are connected and opened by turning on and off the n-MOSFET Tr3. In this way, by providing the n-MOSFET Tr3, whose threshold voltage is the opposite polarity to that of the p-MOSFET Tr1 of Example 1, between the electrical path Ln3 and the electrical path Ln21 connected to the ground terminal T5 side and the electrical path Ln22, one end of which is connected to the terminal T3, the n-MOSFET Tr3 is turned on and off by the same mechanism as the protection circuit 200 of Example 1, and therefore the same effect can be obtained. However, in an electronic device 401 in which the secondary battery is charged by being connected to the charger 102 having such a configuration, the terminal T21 and the terminal T23 are connected inside the electronic device 401. When the terminals T1, T2, and T3 of the charger 102 are connected to the terminals T21, T22, and T23 of the electronic device 401, respectively, and the terminal T1 and the terminal T3 of the charger 102 are short-circuited, the secondary battery of the electronic device 401 is charged.

As described above, according to the present Example 2, safety against a leakage current to a human body can be ensured by the protection circuit 202 having a simple configuration including passive components and transistors.

### Modified Example

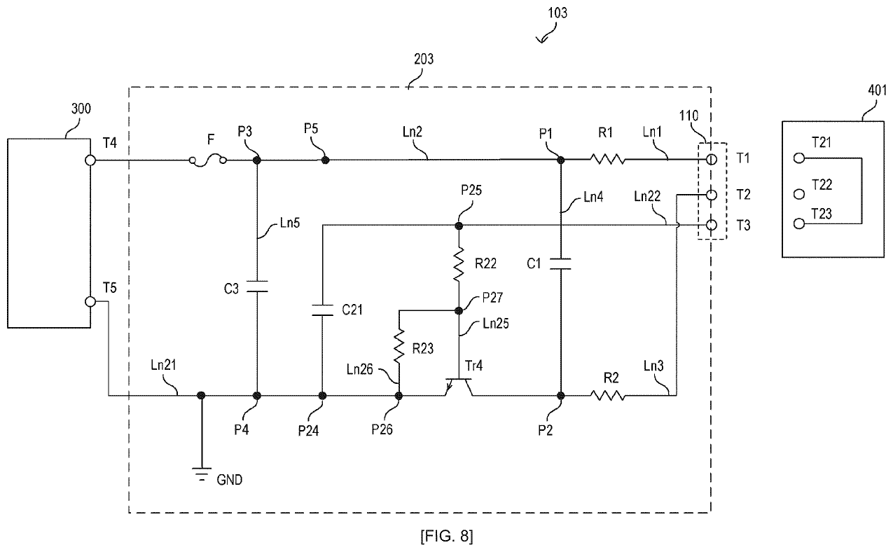

FIG. 8 is a circuit diagram including a protection circuit 203 of a charger 103 according to a modified example of Example 2. The same components as those of the protection circuit 202 according to Example 2 and the protection circuit 200 according to Example 1 are denoted by the same reference numerals, and a detailed description thereof will be omitted.

In the protection circuit 203, an NPN transistor Tr4 is used instead of the n-MOSFET Tr3. Here, a collector terminal of the NPN transistor Tr4 is connected to the terminal T2 by the electrical path Ln3. An emitter terminal of the NPN transistor Tr4 is connected to the ground terminal T5 by the electrical path Ln21. A base terminal of the NPN transistor Tr4 is connected to the electrical path Ln22 by an electrical path Ln25. A resistor R22 is connected in series to the electrical path Ln25, and one end of the electrical path Ln25 is connected to the base terminal of the NPN transistor Tr4 and the other end is connected to the electrical path Ln22 at a connection point P25. A resistor R23 is connected in parallel between the emitter terminal and the base terminal of the NPN transistor Tr4 by an electrical path Ln26. By the electrical path Ln26, one end of the resistor R23 is connected to the electrical path Ln25 at a connection point P27 between the base terminal of the NPN transistor Tr4 and the resistor R22, and the other end is connected to the electrical path Ln21 at a connection point P26 between the emitter terminal of the NPN transistor Tr4 and the connection point P24. Here, the NPN transistor Tr4 corresponds to the NPN transistor of the present invention. In addition, a section from the terminal T3 to the connection point P25 of the electrical path Ln22, a section from the connection point P25 to the connection point P27 of the electrical path Ln25, and a section from the connection point P27 to the connection point P26 of the electrical path Ln26 correspond to the eighth electrical path of the present invention, and a section from the connection point P27 to the base terminal of the NPN transistor Tr4 of the electrical path Ln25 corresponds to the ninth electrical path of the present invention.

The operation when the charger 103 having the protection circuit 203 is connected to the electronic device 400 is the same as that of the charger 102. The operation of the protection circuit 203 when the person 500 touches any two of the terminals T1, T2, and T3 of the charger 103 is the same as that of the protection circuit 202, and a description thereof will be omitted.

As described above, according to the present modified example, safety against a leakage current to a human body can be ensured by the protection circuit 203 having a simple configuration including passive components and transistors.

### Configuration of Charger

Hereinafter, an arrangement configuration of the terminals T1, T2, and T3 in the charger 100 including the protection circuit 200 described above will be described. The chargers 101, 102, and 103 including the protection circuits 201, 202, and 203, respectively, can also adopt the following configuration, and thus individual description thereof will be omitted.

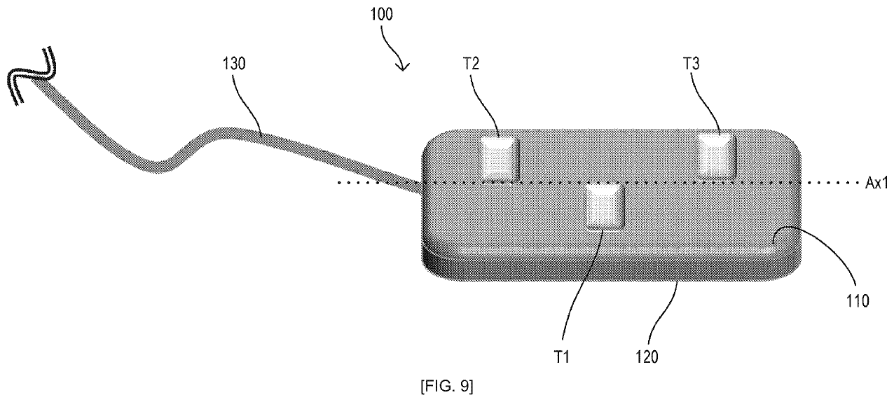

FIG. 9 illustrates an arrangement configuration example of the terminals T1, T2, and T3 in the connector portion 110 of the charger 100. The charger 100 includes a flat and substantially rectangular parallelepiped housing 120 and a cable 130. One end of the cable 130 is connected to the housing 120, and the other end is connected to a power supply such as an AC adapter. In the planar connector portion 110 formed on one surface of the housing 120, the terminal T2, the terminal T1, and the terminal T3 are arranged in this order from the cable 130 side along an axis Ax1 in the longitudinal direction of the connector portion 110. The terminal T1 and the terminals T2 and T3 are arranged asymmetrically with respect to the axis Ax1 in the longitudinal direction of the connector portion 110. That is, the terminal T1 is arranged on one side with respect to the axis Ax1, and the terminals T2 and T3 are arranged on the other side with respect to the axis Ax1. Similarly, the terminals T21, T22, and T23 of the electronic device 400 are arranged asymmetrically with respect to the axes in the arrangement direction in order to come into contact with the terminals T1, T2, and T3 of the charger 100. Therefore, even if an attempt is made to connect the electronic device 400 and the connector portion 110 of the charger 100 in the opposite direction with respect to the arrangement direction of the respective terminals, the electronic device 400 and the charger 100 cannot be appropriately connected, so that the electronic device 400 and the charger 100 can be prevented from being connected in the wrong direction.

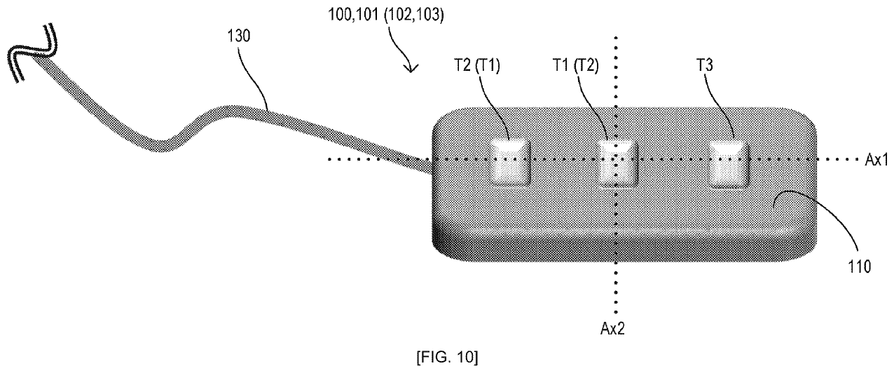

FIG. 10 illustrates another arrangement configuration example of the terminals T1, T2, and T3 in the connector portion 110 of the charger 100 (the same applies to the charger 101). As in FIG. 9, the charger 100 includes the flat and substantially rectangular parallelepiped housing 120 and the cable 130. One end of the cable 130 is connected to the housing 120, and the other end is connected to a power supply such as an AC adapter. In the planar connector portion 110 formed on one surface of the housing 120, the terminal T2, the terminal T1, and the terminal T3 are arranged in this order from the cable 130 side along the axis Ax1 in the longitudinal direction of the connector portion 110. The terminal T1 and the terminals T2 and T3 are arranged symmetrically with respect to the axis Ax1 in the longitudinal direction of the connector portion 110. In addition, at this time, by setting the terminal T1 as a positive electrode and the terminal T2 and the terminal T3 as negative electrodes, the terminal T1 as a positive electrode and the terminal T2 and the terminal T3 as negative electrodes are arranged symmetrically with respect to an axis Ax2 in the direction orthogonal to the longitudinal direction. For this reason, the terminals T21, T22, and T23 of the electronic device 400 also come into contact with the terminals T1, T2, and T3 on the charger 100 side, the three terminals T21, T22, and T23 are arranged symmetrically with respect to the axis Ax1 in the arrangement direction similarly, and with respect to the terminal T21, the terminal T22 and the terminal T23 are arranged symmetrically with respect to the axis Ax2 in the direction orthogonal to the arrangement direction. With such an arrangement, even when the electronic device 400 and the connector portion 110 of the charger 100 are connected to each other in a direction opposite to the arrangement direction of the respective terminals, the electronic device 400 and the charger 100 can be appropriately connected to each other. Therefore, the electronic device 400 and the charger 100 can be connected without concern for the directions of the electronic device 400 and the charger 100, and there is no possibility that the connection is made in a wrong direction and the proper connection cannot be made.

In the connector portion 110, the terminal T2 and the terminal T3 may be reversely arranged.

FIG. 10 illustrates another arrangement configuration of the terminals T1, T2,

and T3 in the connector portion 110 of the charger 102 (the same applies to the charger 103). In FIG. 10, the reference numerals in parentheses indicate the arrangement configuration of the chargers 102 and 103 (the arrangement of the terminal T3 is the same as that of the chargers 100 and 101 described above). At this time, in the planar connector portion 110 formed on one surface of the housing 120, the terminal T1, the terminal T2, and the terminal T3 are arranged along the axis Ax1 in the longitudinal direction of the connector portion 110 in this order from the cable 130 side. The terminal T2, and the terminal T1 and the terminal T3 are arranged symmetrically with respect to the axis Ax1 in the longitudinal direction of the connector portion 110. Further, the terminal T2 as a negative electrode, and the terminal T1 as a positive electrode and the terminal T3 as a negative electrode are arranged symmetrically with respect to the axis Ax2 in the direction orthogonal to the longitudinal direction. At this time, the terminals T21, T22, and T23 of the electronic device 401 also come into contact with the terminals T1, T2, and T3 on the charger 102 side, so the three terminals T21, T22, and T23 are similarly arranged symmetrically with respect to the axis Ax1 of the arrangement direction, and with respect to the terminal T22, the terminal T21 and the terminal T23 are arranged symmetrically with respect to the axis Ax2 perpendicular to the arrangement direction. Therefore, the electronic device 401 and the connector portion 110 of the charger 102 are arranged symmetrically with respect to the arrangement direction of each terminal. With such an arrangement, even when the electronic device 401 and the connector portion 110 of the charger 102 are connected to each other in a direction opposite to the arrangement direction of the respective terminals, the electronic device 401 and the charger 102 can be appropriately connected to each other. Therefore, the electronic device 401 and the charger 102 can be connected without concern for the directions of the electronic device 401 and the charger 102, and there is no possibility that the connection is made in a wrong direction and the proper connection cannot be made.

In the connector portion 110, the terminal T1 and the terminal T3 may be reversely arranged.

### REFERENCE NUMERALS LIST

100, 101, 102, 103 Charger
110 Connector portion
200, 201, 202, 203 Protection circuit
300 Output unit
400 Electronic device
T1, T2, T3 Terminal

1. A protection circuit configured to connect:
a contact positive electrode terminal, a first contact negative electrode terminal, and a second contact negative electrode terminal that are exposed to an outside in a connector portion connected to a device including a secondary battery; and
a positive electrode terminal and a ground terminal provided in a power output unit configured to output power supplied to the secondary battery via the contact positive electrode terminal, the first contact negative electrode terminal, and the second contact negative electrode terminal, wherein
the protection circuit includes:
a P-type metal-oxide-semiconductor field-effect transistor (MOSFET) connected between the contact positive electrode terminal and the positive electrode terminal;
a first electrical path configured to connect the contact positive electrode terminal and a drain terminal of the P-type MOSFET;
a second electrical path configured to connect the positive electrode terminal and a source terminal of the P-type MOSFET;
a third electrical path configured to connect the second electrical path and the first contact negative electrode terminal via a resistor;
a fourth electrical path configured to connect a gate terminal of the P-type MOSFET between the first contact negative electrode terminal and the resistor of the third electrical path; and
a fifth electrical path configured to connect the second contact negative electrode terminal and the ground terminal.

2. A protection circuit configured to connect:
a contact positive electrode terminal, a first contact negative electrode terminal, and a second contact negative electrode terminal that are exposed to an outside in a connector portion connected to a device including a secondary battery; and
a positive electrode terminal and a ground terminal provided in a power output unit configured to output power supplied to the secondary battery via the contact positive electrode terminal, the first contact negative electrode terminal, and the second contact negative electrode terminal, wherein
the protection circuit includes:
a PNP transistor connected between the contact positive electrode terminal and the positive electrode terminal;
a first electrical path configured to connect the contact positive electrode terminal and a collector terminal of the PNP transistor;
a second electrical path configured to connect the positive electrode terminal and an emitter terminal of the PNP transistor;
a third electrical path configured to connect the second electrical path and the first contact negative electrode terminal via a resistor;
a fourth electrical path configured to connect a base terminal of the PNP transistor between the first contact negative electrode terminal and the resistor of the third electrical path; and
a fifth electrical path configured to connect the second contact negative electrode terminal and the ground terminal.

3. A protection circuit configured to connect:
a contact positive electrode terminal, a first contact negative electrode terminal, and a second contact negative electrode terminal that are exposed to an outside in a connector portion connected to a device including a secondary battery; and
a positive electrode terminal and a ground terminal provided in a power output unit configured to output power supplied to the secondary battery via the contact positive electrode terminal, the first contact negative electrode terminal, and the second contact negative electrode terminal, wherein
the protection circuit includes:
an N-type metal-oxide-semiconductor field-effect transistor (MOSFET) connected between the first contact negative electrode terminal and the ground terminal;
a sixth electrical path configured to connect the first contact negative electrode terminal and a drain terminal of the N-type MOSFET;
a seventh electrical path configured to connect the ground terminal and a source terminal of the N-type MOSFET;
an eighth electrical path configured to connect the seventh electrical path and the second contact negative electrode terminal via a resistor;
a ninth electrical path configured to connect a gate terminal of the N-type MOSFET between the first contact negative electrode terminal and the resistor of the eighth electrical path; and
a tenth electrical path configured to connect the contact positive electrode terminal and the positive electrode terminal.

4. A protection circuit configured to connect:
a contact positive electrode terminal, a first contact negative electrode terminal, and a second contact negative electrode terminal that are exposed to an outside in a connector portion connected to a device including a secondary battery; and
a positive electrode terminal and a ground terminal provided in a power output unit configured to output power supplied to the secondary battery via the contact positive electrode terminal, the first contact negative electrode terminal, and the second contact negative electrode terminal, wherein
the protection circuit includes:
an NPN transistor connected between the first contact negative electrode terminal and the ground terminal;
a sixth electrical path configured to connect the first contact negative electrode terminal and a collector terminal of the NPN transistor;
a seventh electrical path configured to connect the ground terminal and an emitter terminal of the NPN transistor;
an eighth electrical path configured to connect the seventh electrical path and the second contact negative electrode terminal via a resistor;
a ninth electrical path configured to connect a base terminal of the NPN transistor between the first contact negative electrode terminal and the resistor of the eighth electrical path; and
a tenth electrical path configured to connect the contact positive electrode terminal and the positive electrode terminal.

5. A charging device comprising the protection circuit according to claim 1, wherein
in the connector portion, the contact positive electrode terminal, the first contact negative electrode terminal, and the second contact negative electrode terminal are arranged asymmetrically.

6. A charging device comprising the protection circuit according to claim 1, wherein
in the connector portion, the first contact negative electrode terminal and the second contact negative electrode terminal are arranged symmetrically with respect to the contact positive electrode terminal.

7. A charging device comprising the protection circuit according to claim 3, wherein
in the connector portion, the contact positive electrode terminal and the second contact negative electrode terminal are arranged symmetrically with respect to the first contact negative electrode terminal.

8. A charging device comprising the protection circuit according to claim 2, wherein
in the connector portion, the contact positive electrode terminal, the first contact negative electrode terminal, and the second contact negative electrode terminal are arranged asymmetrically.

9. A charging device comprising the protection circuit according to claim 2, wherein
in the connector portion, the first contact negative electrode terminal and the second contact negative electrode terminal are arranged symmetrically with respect to the contact positive electrode terminal.

10. A charging device comprising the protection circuit according to claim 3, wherein
in the connector portion, the contact positive electrode terminal, the first contact negative electrode terminal, and the second contact negative electrode terminal are arranged asymmetrically.

11. A charging device comprising the protection circuit according to claim 4, wherein
in the connector portion, the contact positive electrode terminal, the first contact negative electrode terminal, and the second contact negative electrode terminal are arranged asymmetrically.

12. A charging device comprising the protection circuit according to claim 4, wherein
in the connector portion, the contact positive electrode terminal and the second contact negative electrode terminal are arranged symmetrically with respect to the first contact negative electrode terminal.
